(19) United States
(12) Patent Application Publication
(10) Pub. No.: US 2019/0221343 A1
(43) Pub. Date: Jul. 18, 2019

(54) CORE-SHELL PARTICLES, MAGNETO-DIELECTRIC MATERIALS, METHODS OF MAKING, AND USES THEREOF

(71) Applicant: Rogers Corporation, Chandler, AZ (US)

(72) Inventors: Yajie Chen, Brighton, MA (US); Karl Edward Sprentall, Medford, MA (US); Kristi Pance, Auburndale, MA (US)

(21) Appl. No.: 16/242,551

(22) Filed: Jan. 8, 2019

Related U.S. Application Data
(60) Provisional application No. 62/617,661, filed on Jan. 16, 2018.

(51) Int. Cl. H01F 1/33; H01F 1/147; B22F 1/00; B22F 1/02; H01F 1/00; C01G 49/02

(52) U.S. Cl. CPC H01F 1/33; H01F 1/1475; B22F 1/0018; B82Y 25/00; H01F 1/0054; C01G 49/02; B22F 1/025

(57) ABSTRACT

In an aspect, a magnetic particle, comprises a core comprising iron, and a second metal comprising cobalt, nickel, or a combination thereof; wherein a core atomic ratio of the iron to the second metal is 50:50 to 75:25; and a shell at least partially surrounding the core, and comprising an iron oxide, an iron nitride, or a combination thereof, and the second metal. In another aspect, a magneto-dielectric material comprises a polymer matrix and a plurality of the magnetic particles; wherein the magneto-dielectric material has a magnetic loss tangent of less than or equal to 0.07 at 1 GHz.

### CROSS REFERENCE TO RELATED APPLICATION

This application claims the benefit of U.S. Provisional Patent Application Ser. No. 62/617,661 filed Jan. 16, 2018. The related application is incorporated herein in its entirety by reference.

### BACKGROUND

This disclosure relates generally to core-shell particles, magneto-dielectric materials, methods of making, and uses thereof.

Newer designs and manufacturing techniques have driven electronic components to increasingly smaller dimensions, for example, components such as inductors on electronic integrated circuit chips, electronic circuits, electronic packages, modules, housings, and antennas. One approach to reducing electronic component size has been the use of magneto-dielectric materials as substrates. In particular, ferrites, ferroelectrics, and multiferroics have been widely studied as functional materials with enhanced microwave properties. However, these materials are not entirely satisfactory in that they often do not provide the desired bandwidth and they can exhibit a high magnetic loss at high frequencies, such as in the gigahertz range.

There accordingly remains a need in the art for a magneto-dielectric material with a low magnetic loss in the gigahertz range.

### BRIEF SUMMARY

Disclosed herein is a magnetic particle comprising a core comprising iron, and a second metal comprising cobalt, nickel, or a combination thereof, wherein a core atomic ratio of the iron to the second metal is 50:50 to 75:25; and a shell at least partially surrounding the core, and comprising an iron oxide, an iron nitride, or a combination thereof, and the second metal.

A method of making the above magnetic particle comprises oxidizing the core with an oxidizing agent to form the shell; preferably wherein the oxidizing agent comprises oxygen, KMnO₃, H₂O₂, K₂Cr₂O₇, HNO₃, or a combination thereof.

Disclosed herein is a magneto-dielectric material comprising a polymer matrix and a plurality of the magnetic particles, wherein the magneto-dielectric material has a magnetic loss tangent of less than or equal to 0.07 at 1 gigahertz (GHz).

A method of making the above magneto-dielectric material comprises injection molding the polymer and the plurality of magnetic particles.

Another method of making the above magneto-dielectric material comprises reaction injection molding a polymer precursor composition and the plurality of magnetic particles.

Articles comprising the magneto-dielectric material and the composite material are also described, including an antenna, a transformer, an anti-electromagnetic interface material, or an inductor.

The above described and other features are exemplified by the following Figures, Detailed Description, and Claims.

### BRIEF DESCRIPTION OF THE DRAWINGS

The following Figures are exemplary aspects, wherein the like elements are numbered alike.

FIG. 1 is an illustration of an aspect of a cross-section of a core-shell particle;

FIG. 2 is an illustration of an aspect of a magneto-dielectric material;

FIG. 3 is an illustration of an aspect of a conductive layer disposed on the magneto-dielectric material;

FIG. 4 is an illustration of an aspect of a patterned conductive layer disposed on the magneto-dielectric material;

FIG. 5 is an illustration of an aspect of a dual frequency magneto-dielectric material;

FIG. 6 is an illustration of an aspect of preparing a magneto-dielectric material;

FIG. 7 is a scanning electron microscopy image of the magnetic particles of Example 2;

FIG. 8 is a scanning electron microscopy image of the magnetic particles of Example 5;

FIG. 9 is a graphical illustration of the permeability with frequency of Examples 2, 5, and 6;

FIG. 10 is a scanning electron microscopy image of the magnetic particles of Example 7;

FIG. 11 is a scanning electron microscopy image of the magnetic particles of Example 8; and

FIG. 12 is a graphical illustration of the permeability with frequency of Examples 7 and 8.

### DETAILED DESCRIPTION

At high frequencies, for example, greater than or equal to 500 megahertz (MHz), or greater than or equal to 1 GHz, conductive currents are generally concentrated near the conductor surface with the current density decreasing with increasing depth into the conductor and away from the surface. Skin depth is often used to define this decrease in the current density and is defined herein as the depth below the surface where the current density has decreased by e (about 2.78) times from the current density at the surface of the conductor. Specifically, skin depth, δₛ, can be determined by Formula (1)

$${δ}_{s} = \sqrt{\frac{ρ}{π f {μ}_{0} {μ}_{r}}} \qquad ( 1 )$$

where ρ is the bulk resistivity in ohm-meters (Ohm-m), f is the frequency in Hertz, μ₀ is the permeability constant of 4π×10⁻⁷ Henries per meter, and μᵣ is the relativity permeability. Formula (1) illustrates that, for a given material with a bulk resistivity and a relative permeability, as the frequency increases, the skin depth decreases. For magnetic materials, the skin depth is generally further reduced due to an increased relative permeability, making such materials unsuitable for use at high frequencies.

It was surprisingly discovered that a magnetic particle having an increased skin depth could be formed by providing an oxidized shell around a magnetic core. Specifically, the core of the magnetic particle comprises iron and further comprises nickel, cobalt, or a combination thereof; and the shell of the magnetic particle comprises an iron oxide, an iron nitride, or a combination thereof. The presence of a shell that is electrically resistive allows for a reduction in the magnetic loss, while at the same time maintaining a high magnetic permeability and a high resistivity. For example, the shell can have a magnetic permeability of greater than or equal to 5 at a frequency of 1 GHz, or at a frequency of 1 to 10 GHz. The shell can have a resistivity of greater than or equal to 10⁵ Ohm-m. Without being bound by theory, it is believed that a skin depth of the shell can be greater than or equal to 5 millimeters (mm), and as a result, the core-shell magnetic particle overall can have a skin depth that is in the millimeter range, for example, greater than or equal to 5 mm. The skin depth of the core-shell magnetic particle can be reduced by the skin depth of the core, which can be only a few micrometers. The core shell structure can therefore be advantageous in that a particle larger than the skin depth of the core material can be used. In particular, ferromagnetic metal particles having a sub-skin depth size can be difficult to incorporate into polymer compositions, and can be hazardous, for example, flammable, making composites more difficult to manufacture or dangerous to use.

When used in a magneto-dielectric material comprising a polymer matrix and a plurality of the core-shell magnetic particles, it was further found that the magneto-dielectric material can have a magnetic loss tangent at 1 GHz, or 1 to 10 GHz of less than or equal to 0.07. Magneto-dielectric materials with such a low magnetic loss can advantageously be used in high frequency applications such as in antenna applications.

The magnetic particles have a core-shell structure. The core of the magnetic particles comprises iron and further comprises a second metal comprising nickel, cobalt, or a combination thereof. The core can further comprise Cr, Au, Ag, Cu, Gd, Pt, Ba, Bi, Ir, Mn, Mg, Mo, Nb, Nd, Sr, V, Zn, Zr, N, C, or a combination thereof. The core can comprise Ba. The core can comprise 0.001 to 20 atomic percent, or 0.001 to 5 atomic percent of a nonmagnetic metal such as carbon and nitrogen.

The core can comprise iron and the second metal comprising one or both of nickel and cobalt and the atomic ratio of iron to the second metal can be 50:50 to 75:25, or 60:40 to 70:30, or 65:35 to 70:30.

The shell of the magnetic particles at least partially surrounds the core. For example, the shell can cover 5 to 100%, or 10 to 80%, or 10 to 50% of the total surface area of the core material. The shell of the magnetic particles comprises an iron oxide, an iron nitride, or a combination thereof and also comprises the second metal comprising cobalt, nickel, or a combination thereof. The shell can further comprise Cr, Ba, Au, Ag, Cu, Gd, Pt, Bi, Ir, Mn, Mg, Mo, Nb, Nd, Sr, V, Zn, Zr, N, C, or a combination thereof. In an aspect, if one or more of the foregoing is present in the core, it is also present in the shell. The shell can comprise iron nitride. The shell can comprise iron that is not in the form of an iron oxide or an iron nitride. The iron oxide can comprise magnetite (Fe₃O₄). The iron oxide can comprise a metal iron oxide, for example, having the formula MₓFe_{y}O_{z}, wherein M comprises at least one of Co, Ni, Zn, V, Mn, or a combination thereof. Specifically, M can comprise Co, Ni, or a combination thereof. The metal iron oxide can have the formula MFe₂O₄, MFe₁₂O₁₉, Fe₃O₄, MFe₂₄O₄₁, or a combination thereof. Specifically, the metal iron oxide can comprise a metal iron oxide of the formula MFe₂O₄, where M comprises nickel, cobalt, or a combination thereof.

The shell can comprise an oxide of the same or different material as the core. Specifically, the shell can comprise an oxide of the same material as the core. For example, the shell and the core can comprise iron and a second metal, wherein a ratio of the iron to the second metal can be the same, for example, the ratio of the core and the shell can be within 1% of each other.

The shell can insulate the core from environmental degradation. The shell can have a higher resistivity than the core. The shell can have a resistivity of greater than or equal to 10⁵ Ohm-m at a temperature of 23 degrees Celsius (° C.).

The magnetic particles can comprise irregularly-shaped particles, spherical particles, flakes, fibers, rod-shaped particles, needle-shaped particles, or a combination thereof. The magnetic particles can have an aspect ratio referring to a longest dimension to a shortest dimension (for example, a fiber length to a fiber diameter) of greater than or equal to 1, or greater than or equal to 10. The magnetic particles can be solid or hollow.

The magnetic particles can comprise hollow particles, where the particles have a hollow space in the core. While it is not required to provide a description of the theory of operation and the appended claims should not be limited by statements regarding such theory, it is thought that an advantage of a hollow particle is that deeper than one to two skin depths within the magnetic particle, an additional pathway for eddy currents is created without increasing the permeability of the magneto-dielectric material, ultimately resulting in an electrical advantage. The hollow particles can be formed by coating a metal such as iron chloride onto a templating material, for example, polystyrene particles; and removing the templating material, for example, by heating to a temperature above the degradation temperature of the template material. The hollow particles can alternatively be formed by a sol-gel process.

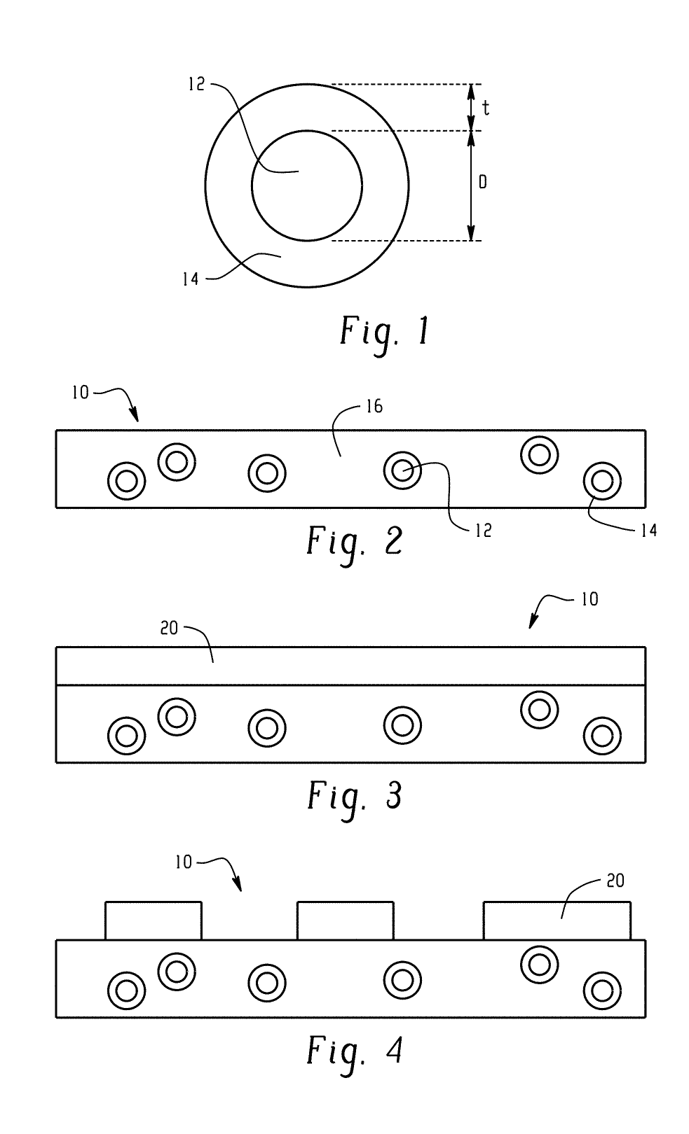

An average shortest dimension of the magnetic particles prior to oxidation can be less than or equal to 6 mm, less than or equal to 5 mm, or 0.01 micrometers to 2 mm, or 0.01 to 0.9 micrometers, or 0.05 to 0.9 micrometers. As used herein, the average shortest dimension refers to an average of the shortest length scale that can be determined for the desired dimension. For example, the average shortest dimension of a spherical particle would refer to the average diameter of spherical particles and the average shortest dimension of a fiber would refer to an average diameter of a cross-section of the fibers. FIG. 1 is an illustration of a cross-section of a core-shell particle (for example, of a sphere or a fiber) having a core 12 and a shell 14. The average shortest dimension of core 12 of the core-shell particle is the diameter, D, and the shell thickness is the thickness, t. The core-shell particles can comprise a discrete boundary between the core and the shell (for example, as illustrated in FIG. 1), or a diffuse boundary can be present between the core and the shell, where the concentration of iron oxide increases from a location on the diffuse boundary with increasing distance from a center of the particle for a distance until the concentration optionally plateaus with further increasing distance from the center to the surface of the particle.

The relative thickness of the shell can be determined by reference to Formula (1). Formula (1) illustrates that if the thickness of the shell is too thin, then the shell will not provide the desired resistivity, and further the particles are likely to agglomerate or an increased quantum tunneling can occur. If the shell is too thick, for example, greater than or equal to the skin depth of the core-shell magnetic particle, then the core may not contribute to the composite permeability of the magnetic particles. Therefore, the shell thickness is selected to be less than or equal to the skin depth, but thick enough to provide the desired resistivity.

In some aspects, and without being bound by theory, the relative thickness, t, of the shell can be determined by reference to Formula (1), with a lower limit for the shell thickness being defined by the quantum tunneling effect, which is not a desired effect because it can result in a significant source of loss. As such, the shell should be thick enough to avoid quantum tunneling of electrons from adjacent core particles. A few nanometers (nm) of thickness is a reasonable assumption for a quantum tunneling length. The quantum tunneling length for most metals is in the range of 1 to 4, more typically 2 to 3 nanometers. For an upper limit, to avoid undesirable changes to the electromagnetic (EM) fields and their sources within the skin depth, a reasonable upper limit for the thickness of the shell is a shell thickness that is less than about 0.25 times the skin depth (δ). For an aspect as disclosed herein, having a skin depth on the order of about 22 mm, a shell thickness on the order of about 5 mm results. Thus, the shell thickness can be 1 to 5 nm, or 2 to 3 nm, or 1 to 22 mm, or 1 to 10 mm, or 1 to 5 mm. To provide a core-shell particle with the desired properties disclosed herein, it is desirable for the shell thickness, t, to be less than the average shortest dimension of the core, D, and for D to be less than 0.25 times the skin depth. Thus, a reasonable upper limit for the shell thickness, t, is, t≤D≤δ/4, with a reasonable lower limit being defined by the quantum tunneling effect as noted above. The average shortest dimension of the core, D, of the plurality of the magnetic particles can vary within the above noted ranges to provide tailored results.

The shell can have a magnetic permeability of greater than or equal to 1, or greater than or equal to 5 at a frequency of 1 GHz, or 1 to 10 GHz.

The magneto-dielectric material can comprise 5 to 60 volume percent (vol %), or 10 to 50 vol %, or 15 to 45 vol %, of magnetic particles based on the total volume of the magneto-dielectric material.

An illustration of an aspect of the magneto-dielectric material is illustrated in FIG. 2 and FIG. 3. FIG. 2 illustrates that magneto-dielectric material 10 comprises a polymer matrix 16 and a plurality of core-shell magnetic particles comprising core 12 and shell 14. FIG. 3 illustrates that the magneto-dielectric material can further comprise conductive layer 20. FIG. 4 illustrates that the magneto-dielectric material can further comprise a patterned conductive layer 20.

The magneto-dielectric material can comprise a dielectric filler. The dielectric filler can comprise, for example, titanium dioxide (including rutile and anatase), barium titanate, strontium titanate, silica (including fused amorphous silica), corundum, wollastonite, Ba₂Ti₉O₂₀, solid glass spheres, synthetic glass or ceramic hollow spheres, quartz, boron nitride, aluminum nitride, silicon carbide, beryllia, alumina, alumina trihydrate, magnesia, mica, talcs, nanoclays, magnesium hydroxide, or a combination thereof.

The dielectric filler can be surface treated with a silicon-containing coating, for example, an organofunctional alkoxy silane coupling agent. A zirconate or titanate coupling agent can be used. Such coupling agents can improve the dispersion of the filler in the polymeric matrix and reduce water absorption of the finished composite circuit substrate. The filler component can comprise 30 to 70 vol % of fused amorphous silica as secondary filler based on the weight of the filler.

The magneto-dielectric material can comprise 5 to 60 vol %, or 10 to 50 vol %, or 15 to 45 vol % of the dielectric filler based on the total volume of the magneto-dielectric material.

The magneto-dielectric material can comprise a flame retardant. The flame retardant can be halogenated or unhalogenated. The flame retardant can be present in the magneto-dielectric material in an amount of 0 to 30 vol % based on the volume of the magneto-dielectric material.

The flame retardant can be inorganic and can be present in the form of particles. The inorganic flame retardant can comprise a metal hydrate, having, for example, a volume average particle diameter of 1 to 500 nm, or 1 to 200 nm, or 5 to 200 nm, or 10 to 200 nm; alternatively, the volume average particle diameter can be 500 nm to 15 micrometers, for example, 1 to 5 micrometers. The metal hydrate can comprise a hydrate of a metal such as Mg, Ca, Al, Fe, Zn, Ba, Cu, Ni, or a combination thereof. Hydrates of Mg, Al, or Ca can be used. Examples of hydrates include aluminum hydroxide, magnesium hydroxide, calcium hydroxide, iron hydroxide, zinc hydroxide, copper hydroxide and nickel hydroxide; and hydrates of calcium aluminate, gypsum dihydrate, zinc borate and barium metaborate. Composites of these hydrates can be used, for example, a hydrate containing Mg and at least one of Ca, Al, Fe, Zn, Ba, Cu, and Ni. A composite metal hydrate can have the formula MgMₓ(OH)_{y} wherein M is Ca, Al, Fe, Zn, Ba, Cu, or Ni, x is 0.1 to 10, and y is 2 to 32. The flame-retardant particles can be coated or otherwise treated to improve dispersion and other properties.

Organic flame retardants can be used, alternatively or in addition to the inorganic flame retardants. Examples of organic flame retardants include melamine cyanurate, fine particle size melamine polyphosphate, various other phosphorus-containing compounds such as aromatic phosphinates, diphosphinates, phosphonates, phosphates, polysilsesquioxanes, siloxanes, and halogenated compounds such as hexachloroendomethylenetetrahydrophthalic acid (HET acid), tetrabromophthalic acid, and dibromoneopentyl glycol. A flame retardant (such as a bromine-containing flame retardant) can be present in an amount of 20 phr (parts per hundred parts of resin) to 60 phr, or 30 to 45 phr based on the total weight of the resin. Examples of brominated flame retardants include Saytex BT93 W (ethylene bistetrabromophthalimide), Saytex 120 (tetradecabromodiphenoxy benzene), and Saytex 102 (decabromodiphenyl oxide).

The flame retardant can be used in combination with a synergist, for example, a halogenated flame retardant can be used in combination with a synergist such as antimony trioxide, and a phosphorus-containing flame retardant can be used in combination with a nitrogen-containing compound such as melamine.

The magnetic particle itself can increase the flame retardancy of the magneto-dielectric material. For example, the magneto-dielectric material can have an improved flame retardancy as compared to the same material without the magnetic particles.

The magneto-dielectric material can have improved flammability. For example, the magneto-dielectric material can have a UL94 V1 or V0 rating at 1.6 mm.

The magneto-dielectric material can operate at a high operating frequency of 0.5 to 10 GHz, or 1 to 5 GHz, or 1 to 10 GHz, or greater than or equal to 1 GHz.

The magneto-dielectric material can have a permeability of 1 to 5, or 1 to 3 as determined at 1 GHz, or from 1 to 10 GHz. The magneto-dielectric material can have a low magnetic loss tangent of less than or equal to 0.07, or 0.01 to 0.07, or less than or equal to 0.03, or less than or equal to 0.01 as determined at 1 GHz, or less than or equal to 0.08, or 0.01 to 0.08 from 1 to 10 GHz.

The magneto-dielectric material can have a low permittivity of less than or equal to 35, or less than or equal to 15, or less than or equal to 5 to 30 as determined at 1 GHz, or 1 to 10 GHz.

The magneto-dielectric material can have a low dielectric loss tangent of less than or equal to 0.005, or less than or equal to 0.001 as determined at 1 GHz, or 1 to 10 GHz.

The core-shell magnetic particles (also referred to herein simply as magnetic particles) can be prepared by oxidizing an outer layer of a plurality of non-oxide magnetic particles to form a metal oxide shell layer. The oxidizing can comprise introducing the plurality of non-oxide magnetic particles to an oxidizing agent such as oxygen (O₂). The oxidizing can comprise introducing the plurality of non-oxide magnetic particles to an oxidizing agent such as KMnO₃, H₂O₂, K₂Cr₂O₇, HNO₃, and the like, or a combination thereof. The oxidizing the core can occur at 50 to 300° C. for 2 hours to 14 days. After the oxidizing, the core-shell particle can be separated from the oxidizing agent and optionally washed, dried, and optionally sieved to select for a particle size range.

The core-shell magnetic particles can be prepared by coating a core magnetic particle with carbon, heating the core magnetic particle under reducing conditions to convert the carbon to a hydrocarbon, and oxidizing the core magnetic particle to form the core-shell magnetic particle.

The polymer matrix can comprise a thermoset or a thermoplastic polymer, including a liquid crystalline polymer. The polymer can comprise a polycarbonate, a polystyrene, a polyphenylene ether, a polyimide (e.g., polyetherimide), a polybutadiene, a polyacrylonitrile, a poly(C₁₋₁₂alkyl)methacrylate (e.g., polymethylmethacrylate (PMMA)), a polyester (e.g., poly(ethylene terephthalate), polybutylene terephthalate), or polythioester), a polyolefin (e.g., polypropylene (PP), high density polyethylene (HDPE), low density polyethylene (LDPE), or linear low density polyethylene (LLDPE)), a polyamide (e.g., polyamideimide), a polyarylate, a polysulfone (e.g., polyarylsulfone or polysulfonamide), a poly(phenylene sulfide), a poly(phenylene oxide), a polyethers (e.g., poly(ether ketone) (PEK), poly(ether ether ketone) (PEEK), polyethersulfone (PES)), a polyacrylic, a polyacetal, a polybenzoxazoles (e.g., polybenzothiazole or polybenzothiazinophenothiazine), a polyoxadiazole, a polypyrazinoquinoxaline, a polypyromellitimide, a polyquinoxaline, a polybenzimidazole, a polyoxindole, a polyoxoisoindoline (e.g., polydioxoisoindoline), a polytriazine, a polypyridazine, a polypiperazine, a polypyridine, a polypiperidine, a polytriazole, a polypyrazole, a polypyrrolidine, a polycarborane, a polyoxabicyclononane, a polydibenzofuran, a polyphthalide, a polyacetal, a polyanhydride, a vinyl polymer (e.g., a poly(vinyl ether), a poly(vinyl thioether), a poly(vinyl alcohol), a poly(vinyl ketone), a poly(vinyl halide) (such as polyvinylchloride), a poly(vinyl nitrile), or a poly(vinyl ester)), a polysulfonate, a polysulfide, a polyurea, a polyphosphazene, a polysilazane, a polysiloxane, a fluoropolymer (e.g., poly(vinyl fluoride) (PVF), poly(vinylidene fluoride) (PVDF), fluorinated ethylene-propylene (FEP), polytetrafluoroethylene (PTFE), or polyethylenetetrafluoroethylene (PETFE)), or a combination thereof. The polymer can comprise a poly(ether ether ketone), a poly(phenylene oxide), a polycarbonate, a polyester, an acrylonitrile-butadiene-styrene copolymer, a styrene-butadiene copolymer, a styrene-ethylene-propylene copolymer, a nylon, or a combination thereof. The polymer can comprise a high-temperature nylon. The polymer can comprise a polyethylene (such as a high-density polyethylene). The polymer matrix can comprise a polyolefin, a polyurethane, a polyethylene (such as polytetrafluoroethylene), a silicone (such as polydimethylsiloxane), a polyether (such as poly(ether ketone) and poly(ether ether ketone)), poly(phenylene sulfide), or a combination thereof.

The polymer of the polymer matrix composition can comprise a thermosetting polybutadiene or polyisoprene. As used herein, the term “thermosetting polybutadiene or polyisoprene” includes homopolymers and copolymers comprising units derived from butadiene, isoprene, or mixtures thereof. Units derived from other copolymerizable monomers can also be present in the polymer, for example, in the form of grafts. Copolymerizable monomers include, but are not limited to, vinylaromatic monomers, for example, substituted and unsubstituted monovinylaromatic monomers such as styrene, 3-methylstyrene, 3,5-diethylstyrene, 4-n-propylstyrene, alpha-methylstyrene, alpha-methyl vinyltoluene, para-hydroxystyrene, para-methoxystyrene, alpha-chlorostyrene, alpha-bromostyrene, dichlorostyrene, dibromostyrene, tetra-chlorostyrene, and the like; and substituted and unsubstituted divinylaromatic monomers such as divinylbenzene, divinyltoluene, and the like. Combinations comprising copolymerizable monomers can be used. Thermosetting polybutadienes or polyisoprenes include, but are not limited to, butadiene homopolymers, isoprene homopolymers, butadiene-vinylaromatic copolymers such as butadiene-styrene, isoprene-vinylaromatic copolymers such as isoprene-styrene copolymers, and the like.

The thermosetting polybutadiene or polyisoprene polymers can also be modified. For example, the polymers can be hydroxyl-terminated, methacrylate-terminated, carboxylate-terminated, or the like. Post-reacted polymers can be used, such as epoxy-, maleic anhydride-, or urethane-modified polymers of butadiene or isoprene polymers. The polymers can also be crosslinked, for example, by divinylaromatic compounds such as divinyl benzene, e.g., a polybutadiene-styrene crosslinked with divinyl benzene. Polymers are broadly classified as “polybutadienes” by their manufacturers, for example, Nippon Soda Co., Tokyo, Japan, and Cray Valley Hydrocarbon Specialty Chemicals, Exton, Pa. Mixtures of polymers can also be used, for example, a mixture of a polybutadiene homopolymer and a poly(butadiene-isoprene) copolymer. Combinations comprising a syndiotactic polybutadiene can also be useful.

A curing agent can be used to cure the thermosetting polybutadiene or polyisoprene composition to accelerate the curing reaction. Curing agents can comprise organic peroxides, for example, dicumyl peroxide, t-butyl perbenzoate, 2,5-dimethyl-2,5-di(t-butyl peroxy)hexane, α,α-di-bis(t-butyl peroxy)diisopropylbenzene, 2,5-dimethyl-2,5-di(t-butyl peroxy) hexyne-3, or a combination thereof. Carbon-carbon initiators, for example, 2,3-dimethyl-2,3 diphenylbutane can be used. Curing agents or initiators can be used alone or in combination. The amount of curing agent can be 1.5 to 10 weight percent (wt %) based on the total weight of the polymer in the polymer matrix.

The polymer matrix can comprise a norbornene polymer derived from a monomer composition comprising a norbornene monomer, a norbornene-types monomer, or a combination thereof.

The polynorbornene matrix can be derived from a monomer composition comprising one or both of a norbornene monomer and a norbornene-type monomer, as well as other optional co-monomers. A repeat unit derived from norbornene is shown below in Formula (I).

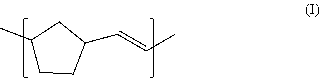

Norbornene-type monomers include tricyclic monomers (such as dicyclopentadiene and dihydrodicyclopentadiene); tetracyclic monomers (such as tetracyclododecene); and pentacyclic monomers (such as tricyclopentadiene); heptacyclic monomers (such as tetracyclopentadiene). A combination thereof can be used. One of the foregoing monomers can be used to obtain a homopolymer or two or more can be combined to obtain a copolymer.

The norbornene-type monomer can comprise dicyclopentadiene such that the polynorbornene matrix comprises a repeat unit derived from the dicyclopentadiene as illustrated below in Formula (II).

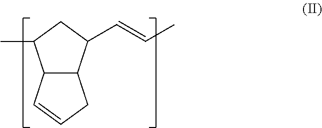

The polynorbornene matrix can comprise 50 to 100 wt %, or 75 to 100 wt %, or 95 to 100 wt % of repeat units derived from dicyclopentadiene based on the total weight of the polynorbornene matrix.

The norbornene-type monomer can comprise a functional group such an alkyl group (e.g., methyl, ethyl, propyl, or butyl), an alkylidene group (e.g., ethylidene), an aryl group (e.g., phenyl, tolyl, or naphthyl), a polar group (e.g., ester, ether, nitrile, or halogen), or a combination thereof. An example of a norbornene-type monomer with an ethylidene functional group is ethylidene norbornene, as shown below in Formula (III).

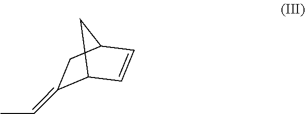

The functionalized repeat unit can be present in the polynorbornene matrix in an amount of 5 to 30 wt %, or 15 to 28 wt %, or 20 to 25 wt % based on the total weight of the polynorbornene matrix.

The polynorbornene matrix can contain less than or equal to 20 wt % of at least one of a repeat unit derived from a copolymerizable monomer based on the total weight of the polynorbornene matrix. The copolymerizable monomer can comprise a monocycloolefin, a bicycloolefin, or a combination thereof. The monocycloolefin and the bicycloolefin can each independently comprise 4 to 16 carbon atoms, or 4 to 8, or 8 to 12 carbon atoms. The bicycloolefin can comprise 1 to 4 double bonds, or 2 to 3 double bonds. The copolymerizable monomer can comprise norbornadiene, 2-norbornene, 5-methyl-2-norbornene, 5-hexyl-2-norbornene, 5-ethylidene-2-norbornene, vinylnorbornene, 5-phenyl-2-norbornene, cyclobutene, cyclopentene, cyclopentadiene, cycloheptene, cyclooctene, cyclooctadiene, cyclodecene, cyclododecene, cyclododecadiene, cyclododecatriene, norbornadiene, or a combination comprising at least of the foregoing.

The polynorbornene matrix can be formed by ring-opening metathesis polymerization (ROMP) of the monomer in the presence of a catalyst system comprising a metathesis catalyst and an activating agent. The catalyst system can optionally comprise a moderator, a fluorinated compound, a chelating agent, a solvent, or a combination thereof.

The magneto-dielectric material can be formed by injection molding, reaction injection molding, extruding, compression molding, a rolling technique, and the like. A paste, grease, or slurry of the magneto-dielectric material can be prepared, for example, for use as a coating or a sealant. For isotropic magneto-dielectric materials, the magneto-dielectric material can be formed in the absence of an external magnetic field. Conversely, for anisotropic magneto-dielectric materials, the magneto-dielectric material can be formed in the presence of an external magnetic field. The external magnetic field can be 1 to 20 kilooersteds (kOe).

The magneto-dielectric material can be formed using an injection molding process comprising injection molding a molten magnetic composition comprising a polymer and the magnetic particles. A method of forming the magneto-dielectric material can comprise forming a composition comprising a polymer and the magnetic particles; and mixing the composition, wherein the polymer can be melted prior to mixing or after mixing.

The magneto-dielectric material can be prepared by reaction injection molding a thermosetting composition. The reaction injection molding can comprise mixing at least two streams to form a thermosetting composition and injecting the thermosetting composition into the mold, wherein a first stream can comprise a catalyst and the second stream can comprise an activating agent. One or both of the first stream and the second stream or a third stream can comprise a monomer. One or both of the first stream and the second stream or a third stream can comprise at least one of a cross-linking agent, a magnetic particle, and an additive. One or both of the magnetic particle and the additive can be added to the mold prior to injecting the thermosetting composition.

The mixing can occur in a head space of an injection molding machine. The mixing can occur in an inline mixer. The mixing can occur during injecting into the mold. The mixing can occur at a temperature of greater than or equal to 0 to 200° C., or 15 to 130° C., or 0 to 45° C., or 23 to 45° C.

The mold can be maintained at a temperature of greater than or equal to 0 to 250° C., or 23 to 200° C., or 45 to 250° C., or 30 to 130° C., or 50 to 70° C. It can take 0.25 to 0.5 minutes to fill a mold, during which time, the mold temperature can drop. After the mold is filled, the temperature of the thermosetting composition can increase, for example, from a first temperature of 0° to 45° C. to a second temperature of 45 to 250° C. The molding can occur at a pressure of 65 to 350 kiloPascal (kPa). The molding can occur for less than or equal to 5 minutes, or less than or equal to 2 minutes, or 2 to 30 seconds. After the polymerization is complete, the magneto-dielectric material can be removed at the mold temperature or at a decreased mold temperature. For example, the release temperature, Tᵣ, can be less than or equal to 10° C. less than the molding temperature, Tₘ (Tᵣ≤Tₘ−10° C.).

After the magneto-dielectric material is removed from the mold, it can be post-cured. Post-curing can occur at a temperature of 100 to 150° C., or 140 to 200° C. for greater than or equal to 5 minutes.

The magneto-dielectric material can be a reinforced magneto-dielectric material, for example, comprising a glass cloth. The reinforced magneto-dielectric material can be formed by impregnating and laminating a composition comprising the polymer and the core-shell magnetic particles onto a reinforcing medium. The reinforcing medium can be fibrous, for example, a woven or a non-woven fibrous layer. The reinforcing medium can have macroscopic voids allowing for the composition to fully impregnate the reinforcing medium. The reinforcing medium can comprise a glass cloth.

FIG. 6 illustrates a method of forming a magneto-dielectric material starting with a plurality of magnetic particle of Step I. Step II illustrates that the core-shell particles are prepared. Step II can comprise oxidizing the core with an oxidizing agent to form the shell; preferably wherein the oxidizing agent comprises oxygen, KMnO₃, H₂O₂, K₂Cr₂O₇, HNO₃, or a combination thereof. The oxidizing of the core can occur at 50 to 300° C. for 2 hours to 14 days. After the oxidizing, the core-shell particle can be separated from the oxidizing agent and optionally washed, dried, and sieved to select for a particle size range. Step III illustrates that the plurality of core-shell magnetic particles can be mixed with a polymer to form a mixture. Step IV illustrates that the mixture can be molded, for example, by compression molding, injection molding, reaction injection molding, and the like to form the magneto-dielectric material. Step V illustrates that the mixture can be impregnated and laminated onto a reinforcing medium such as a glass cloth to form a reinforced magneto-dielectric material.

The magneto-dielectric material can be in the form of an article, for example, a layer, and further comprise a conductive layer, for example, copper. The conductive layer can have a thickness of 3 to 200 micrometers, or 9 to 180 micrometers. Suitable conductive layers include a thin layer of a conductive metal such as a copper foil presently used in the formation of circuits, for example, electrodeposited copper foils. The copper foil can have a root mean squared (RMS) roughness of less than or equal to 2 micrometers, or less than or equal to 0.7 micrometers, where roughness is measured using a Veeco Instruments WYCO Optical Profiler, using the method of white light interferometry.

The conductive layer can be applied by placing the conductive layer in the mold prior to molding, by laminating the conductive layer onto the magneto-dielectric material, by direct laser structuring, or by adhering the conductive layer to the substrate via an adhesive layer. For example, a laminated substrate can comprise an optional polyfluorocarbon film that can be located in between the conductive layer and the magneto-dielectric material, and a layer of microglass reinforced fluorocarbon polymer that can be located in between the polyfluorocarbon film and the conductive layer. The layer of microglass reinforced fluorocarbon polymer can increase the adhesion of the conductive layer to the magneto-dielectric material. The microglass can be present in an amount of 4 to 30 wt % based on the total weight of the layer. The microglass can have a longest length scale of less than or equal to 900 micrometers, or 50 to 500 micrometers. The microglass can be microglass of the type as commercially available by Johns-Manville Corporation of Denver, Colo. The polyfluorocarbon film comprises a fluoropolymer (such as PTFE), a fluorinated ethylene-propylene copolymer (such as TEFLON FEP), or a copolymer having a tetrafluoroethylene backbone with a fully fluorinated alkoxy side chain (such as TEFLON PFA)).

The conductive layer can be applied by laser direct structuring. Here, the magneto-dielectric material can comprise a laser direct structuring additive, a laser is used to irradiate the surface of the substrate, forming a track of the laser direct structuring additive, and a conductive metal is applied to the track. The laser direct structuring additive can comprise a metal oxide particle (such as titanium oxide and copper chromium oxide). The laser direct structuring additive can comprise a spinel-based inorganic metal oxide particle, such as spinel copper. The metal oxide particle can be coated, for example, with a composition comprising tin and antimony (for example, 50 to 99 wt % of tin and 1 to 50 wt % of antimony, based on the total weight of the coating). The laser direct structuring additive can comprise 2 to 20 parts of the additive based on 100 parts of the respective composition. The irradiating can be performed with a YAG laser having a wavelength of 1064 nanometers under an output power of 10 Watts, a frequency of 80 kHz, and a rate of 3 meters per second. The conductive metal can be applied using a plating process in an electroless plating bath comprising, for example, copper.

Alternatively, the conductive layer can be applied by adhesively applying the conductive layer. In an aspect, the conductive layer is the circuit (the metallized layer of another circuit), for example, a flex circuit. For example, an adhesion layer can be disposed between one or both of the conductive layer(s) and the substrate. The adhesion layer can comprise a poly(arylene ether); and a carboxy-functionalized polybutadiene or polyisoprene polymer comprising butadiene, isoprene, or butadiene and isoprene units, and zero to less than or equal to 50 wt % of co-curable monomer units; wherein the composition of the adhesive layer is not the same as the composition of the substrate layer. The adhesive layer can be present in an amount of 2 to 15 grams per square meter. The poly(arylene ether) can comprise a carboxy-functionalized poly(arylene ether). The poly(arylene ether) can be the reaction product of a poly(arylene ether) and a cyclic anhydride, or the reaction product of a poly(arylene ether) and maleic anhydride. The carboxy-functionalized polybutadiene or polyisoprene polymer can be a carboxy-functionalized butadiene-styrene copolymer. The carboxy-functionalized polybutadiene or polyisoprene polymer can be the reaction product of a polybutadiene or polyisoprene polymer and a cyclic anhydride. The carboxy-functionalized polybutadiene or polyisoprene polymer can be a maleinized polybutadiene-styrene or maleinized polyisoprene-styrene copolymer. Other methods known in the art can be used to apply the conductive layer where admitted by the particular materials and form of the circuit material, for example, electrodeposition, chemical vapor deposition, lamination, or the like.

The conductive layer can be a patterned conductive layer. The magneto-dielectric material can comprise a first conductive layer and a second conductive layer located on opposite sides of the magneto-dielectric material.

An article can comprise the magneto-dielectric material. The article can be an antenna. The article can be a microwave device, such as an antenna or an inductor. The article can be a transformer, an antenna, an inductor, or an anti-electromagnetic interface material. The article can be an antenna such as a patch antenna, an inverted-F antenna, or a planar inverted-F antenna. The article can be a magnetic bus bar, for example, for wireless charging; an NFC shielding material; or an electronic bandgap meta-material.

The magneto-dielectric material can be used in microwave absorption or microwave shielding applications.

The article can be a multi-frequency article comprising the magneto-dielectric material and a dielectric material that comprises 0 to 2 vol % of the magnetic particles based on the total volume of the dielectric material. The dielectric material can comprise the same or different polymer as the magneto-dielectric material and the same or a different filler (for example, a dielectric filler or a flame retardant). The multi frequency article can be capable of being used as an antenna where the dielectric material operates at a first frequency range and a magneto-dielectric material operates at a second frequency range. For example, one of the magneto-dielectric material and the dielectric material can operate at frequencies of greater than or equal to a value of 6 to 8 GHz and the other can operate at frequencies of less than that value. The specific value of 6 to 8 can depend on the antenna type and the tolerance of the loss in that antenna.

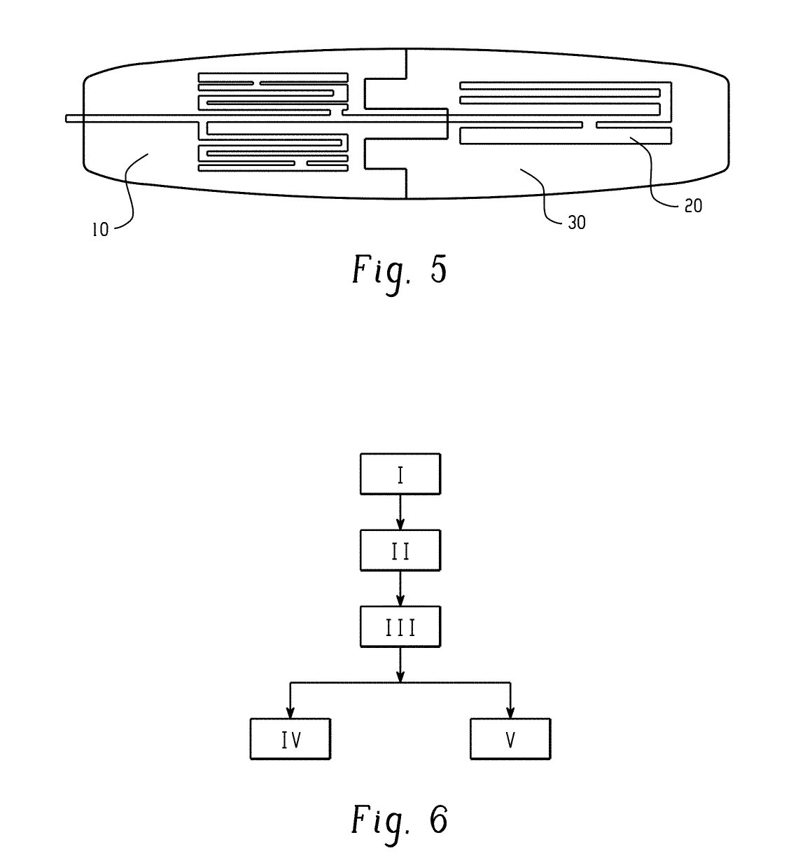

FIG. 5 is an illustration of a top view of a multi frequency magneto-dielectric material, where first conductive layer 20 is disposed on top of magneto-dielectric substrate 10 and dielectric substrate 30. FIG. 5 illustrates that the first conductive layer 20 can be asymmetrical with respect to magneto-dielectric substrate 10 and dielectric substrate 30. Conversely, the first conductive layer 20 can be symmetrical on magneto-dielectric substrate 10 and dielectric substrate 30. For example, the conductive layer can be patterned on each of the magneto-dielectric substrate and the dielectric substrate based on the desired radiation frequency and the substrate characteristics to resonate and radiate in the desired frequency range. The multi frequency magneto-dielectric material can be formed by a two-shot injection molding process (for example, of a thermoplastic or a thermoset material by reaction injection molding) comprising first injection molding one of the magneto-dielectric material and the dielectric material and then, second, injection molding the second of the magneto-dielectric material and the dielectric material.

The following examples are provided to illustrate the present disclosure. The examples are merely illustrative and are not intended to limit devices made in accordance with the disclosure to the materials, conditions, or process parameters set forth therein.

### EXAMPLES

In the examples, the magnetic particles were prepared by mixing raw powders of Fe and Ni in a polyurethane jar with Φ3 mm stainless steel balls for 2 to 24 hours. In accordance with the parameters set forth in Table 1, the mixed powder was then fed to a radio-frequency (RF) induction thermal plasma system by a carrier gas of argon and hydrogen, introduced to a plasma jet, and then cooled using a quenching gas of argon to form a plurality of particles. The particles were then collected in the collection chamber.

TABLE 1

| Processing Parameters | Value |
|---|---|
| Power of thermal plasma | 30 kilowatts |
| Voltage of thermal plasma | 10.5 kilovolts |
| Current of thermal plasma | 3.5 Ampere |
| Central gas, Ar | 2.0 meters cubed per hour |
| Sheath gas, Ar | 2.0 meters cubed per hour |
| Cooling gas, Ar | 2.0 meters cubed per hour |
| Carrier gas, H₂ | 50 to 100 liters per hour |
| Carrier gas, Ar | 100 to 150 meters cubed per hour |

In order to determine the electromagnetic properties of the magnetic particles, the magnetic particles were mixed with paraffin and pressed into 3×7×2 millimeter toroids for the electromagnetic property measurement (magnetic permeability and permittivity) by Vector Network Analyzer (VNA) with a coaxial line in Nicholson-Ross-Weir (NRW) method. Unless stated otherwise, the toroids comprised 40 volume percent of the magnetic particles and 60 volume percent of the paraffin.

### Examples 1-4: Preparation of Magnetic Particles

Four samples of magnetic particles were prepared by varying the combined feed rate of the iron and nickel powder into the plasma chamber. Feed rates of 0.5 grams per minute (g/min), 1 g/min, 2 g/min, and 5 g/min for mixed Ni and Fe powders were used to form the magnetic particles of Examples 1-4, respectively, and resulted in magnetic Fe₆₆Ni₃₄ particles having an average particle sizes of 50 nm, 70 nm, 100 nm, and 120 nm.

Specific values of the relative permeability (μ′), the magnetic loss tangent (tan(δ_{μ})), the specific magnetic loss tangent (tan(δ_{μ})/μ′), and the relative permittivity (E′), at different frequencies as well as the resonance frequency (fᵣ) are shown in Table 2.

TABLE 2

| | | Example | | | |
|---|---|---|---|---|---|
| | | 1 | 2 | 3 | 4 |
| Frequency | Particle size (nm) | 50 | 70 | 100 | 120 |
| 1 GHz | μ′ | 1.94 | 1.83 | 3.39 | 3.37 |
| | tanδ_{μ} | 0.173 | 0.154 | 0.381 | 0.312 |
| | tanδ_{μ}/μ′ | 0.089 | 0.084 | 0.112 | 0.093 |
| | ε′ | 25 | 19 | 50 | 45 |
| 2 GHz | μ′ | 1.93 | 1.83 | 2.83 | 2.77 |
| | tanδ_{μ} | 0.063 | 0.073 | 0.438 | 0.400 |
| | tanδ_{μ}/μ′ | 0.033 | 0.04 | 0.155 | 0.144 |
| | ε′ | 24 | 18 | 53 | 44 |
| 3 GHz | μ′ | 1.69 | 1.63 | 2.38 | 2.25 |
| | tanδ_{μ} | 0.073 | 0.083 | 0.518 | 0.486 |
| | tanδ_{μ}/μ′ | 0.043 | 0.051 | 0.217 | 0.216 |
| | ε′ | 23 | 18 | 48 | 39 |
| 4 GHz | μ′ | 1.61 | 1.52 | 1.98 | 1.95 |
| | tanδ_{μ} | 0.076 | 0.091 | 0.701 | 0.546 |
| | tanδ_{μ}/μ′ | 0.047 | 0.060 | 0.354 | 0.280 |
| | ε′ | 23 | 18 | 40 | 33 |

| | | | | |
|---|---|---|---|---|
| Resonance frequency, fᵣ | 3.6 | 3.5 | 4.0 | 4.0 |
| (GHz) | | | | |

### Examples 5 and 6: Preparation of 70 nm Core-Shell Magnetic Particles

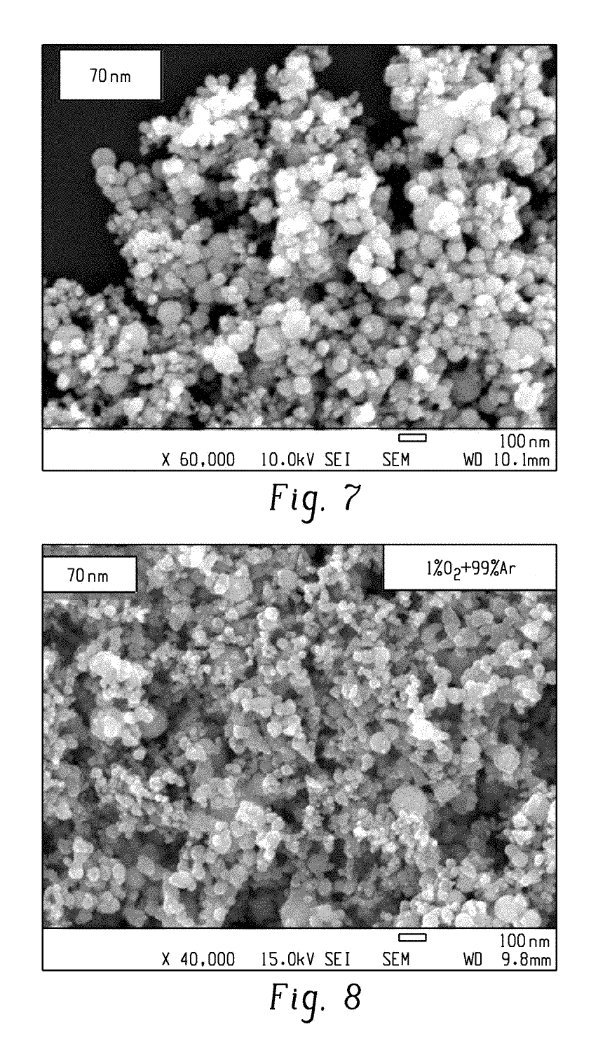

The particles of Example 2 having an average particle size of 70 nm were annealed in a low oxygen environment of 1 volume percent oxygen in argon at 500° C. for 30 minutes to form the shell on the nanoparticles. The resulting core-shell nanoparticles had a shell with a thickness of 2 to 50 nanometers. FIG. 7 and FIG. 8 are scanning electron microscopy images of the particles before and after annealing in oxygen, respectively.

The electromagnetic properties of the core-shell magnetic particles were then determined for the particles of Example 2 and Example 5 as described above. In Example 6, the electromagnetic properties of the same core-shell magnetic particles of Example 5 were determined, but using toroids comprising 60 volume percent of the core-shell magnetic particles.

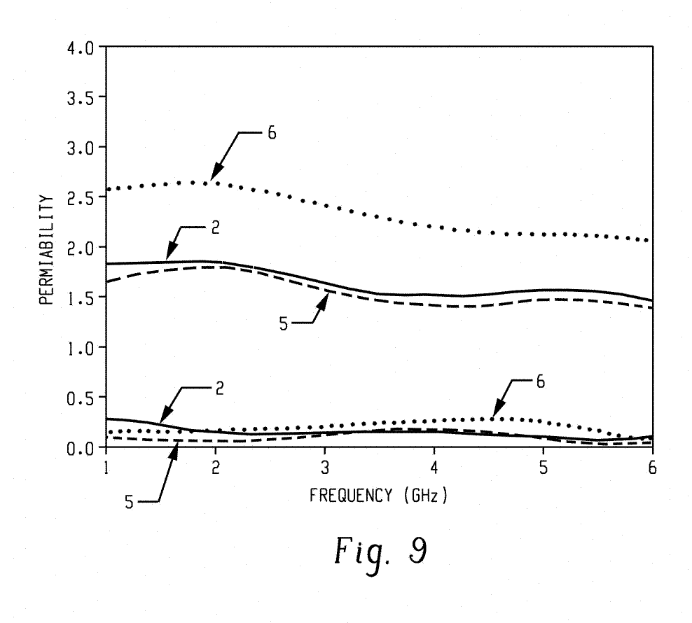

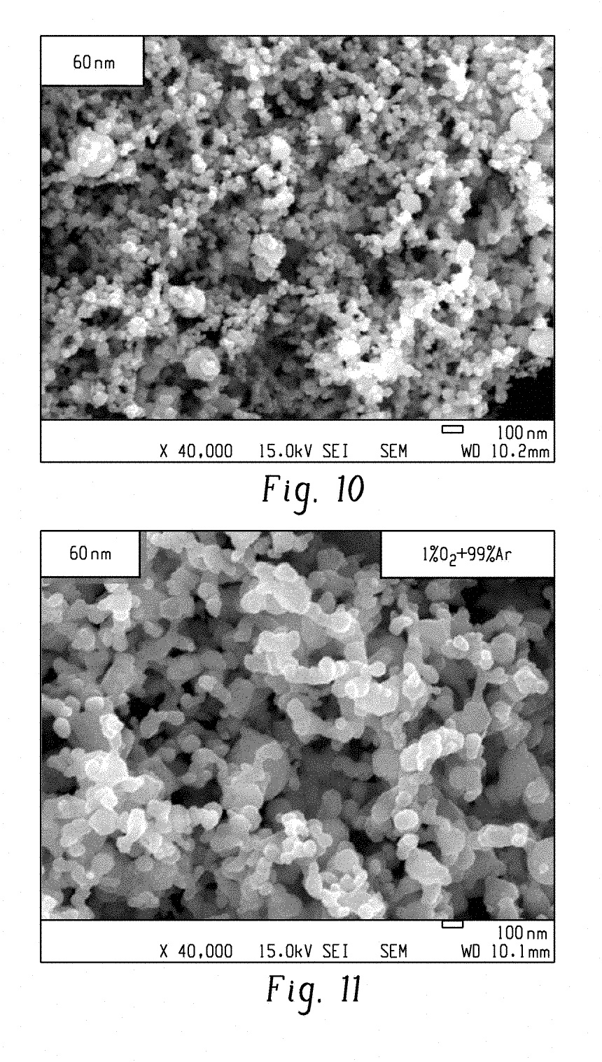

The real (μ′) and imaginary (μ″) parts of the permeability for unannealed magnetic particles are shown in FIG. 9 for the magnetic particles of Example 2 and the core-shell magnetic particles of Example 5 and Examples 6, where the upper lines for each examples are the real (μ′) parts and the lower lines are the imaginary (μ″) parts for each example. Specific values of the relative permeability (μ′), the magnetic loss tangent (tan(δ_{μ})), and the relative permittivity (ε′), at different frequencies as well as the resonance frequency (fᵣ) are shown in Table 3, where NPs stands for nanoparticles.

TABLE 3

| | Vol % | 1 GHz | | | 2 GHz | | | 3 GHz | | | fᵣ |
|---|---|---|---|---|---|---|---|---|---|---|---|
| Example | of NPs | μ′ | tanδ_{μ} | ε′ | μ′ | tanδ_{μ} | ε′ | μ′ | tanδ_{μ} | ε′ | (GHz) |
| 2 | 40 | 1.83 | 0.154 | 18 | 1.83 | 0.073 | 18 | 1.63 | 0.083 | 18 | 3.5 |
| 5 | 40 | 1.66 | 0.064 | 11 | 1.82 | 0.029 | 11 | 1.60 | 0.079 | 11 | 3.7 |
| 6 | 60 | 2.57 | 0.053 | 33 | 2.61 | 0.054 | 32 | 2.42 | 0.081 | 32 | 4.5 |

The figures and Table 3 show that the magnetic loss is significantly reduced by the presence of the shell.

### Examples 7 and 8: Preparation of 60 nm Core-Shell Magnetic Particles

Nano particles having an average particle size of 60 nm were prepared in accordance with Example 5. The resulting core-shell nanoparticles had a shell with a thickness of 2 to 25 nanometers. FIG. 10 and FIG. 11 are scanning electron microscopy images of the particles before (Example 7) and after annealing in oxygen (Example 8), respectively.

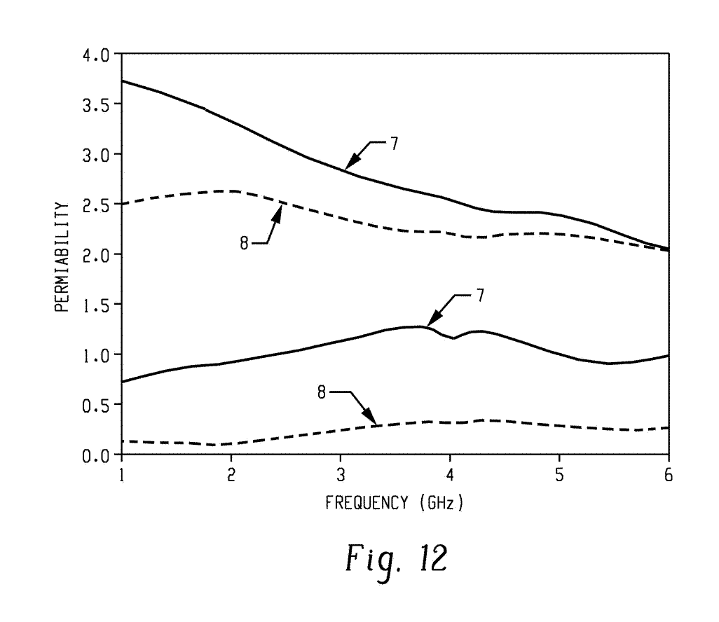

The electromagnetic properties of the core-shell magnetic particles were then measured. The real (μ′) part (upper lines) and imaginary (μ″) part (lower lines) of the permeability for unannealed magnetic particles are shown in FIG. 12 for the magnetic particles and the core-shell magnetic particles. Specific values of the relative permeability (μ′), the magnetic loss tangent (tan(δ_{μ})), and the relative permittivity (ε′), at different frequencies as well as the resonance frequency (fᵣ) are shown in Table 4.

TABLE 4

| Ex- | | | | | | | | | | |
|---|---|---|---|---|---|---|---|---|---|---|
| am- | 1 GHz | | | 2 GHz | | | 3 GHz | | | fᵣ |
| ple | μ′ | tanδ_{μ} | ε′ | μ′ | tanδ_{μ} | ε′ | μ′ | tanδ_{μ} | ε′ | (GHz) |
| 7 | 3.71 | 0.192 | 68 | 3.33 | 0.274 | 64 | 2.85 | 0.391 | 62 | 4 |
| 8 | 2.49 | 0.062 | 27 | 2.62 | 0.048 | 26 | 2.36 | 0.106 | 26 | 4 |

The figures and Table 4 show that the magnetic loss is significantly reduced by the presence of the shell.

Set forth below are non-limiting aspects of the present core-shell particles, magneto-dielectric materials, methods of making, and uses thereof.

Aspect 1: A magnetic particle, comprising: a core comprising iron, and a second metal comprising cobalt, nickel, or a combination thereof; wherein a core atomic ratio of the iron to the second metal is 50:50 to 75:25; and a shell at least partially surrounding the core, and comprising an iron oxide, an iron nitride, or a combination thereof, and the second metal.

Aspect 2: The magnet particle of Aspect 1, wherein the shell has at least one of a higher resistivity than the core, or a magnetic permeability of greater than or equal to 1, or greater than or equal to 5 as determined at 1 GHz.

Aspect 3: The magnetic particle of any one or more of the foregoing aspects, wherein at least one of the core or the shell further comprises Cr, Ba, Au, Ag, Cu, Gd, Pt, Bi, Ir, Mn, Mg, Mo, Nb, Nd, Sr, V, Zn, Zr, N, C, or a combination thereof, preferably wherein the core and the shell further comprise the same one or more of Cr, Ba, Au, Ag, Cu, Gd, Pt, Bi, Ir, Mn, Mg, Mo, Nb, Nd, Sr, V, Zn, Zr, N, C, or a combination thereof.

Aspect 4: The magnetic particle of any one or more of the foregoing aspects, wherein the core atomic ratio of the iron to the second metal is 60:40 to 70:30, or 65:35 to 70:30.

Aspect 5: The magnetic particle of any one or more of the foregoing aspects, wherein a shell atomic ratio of the iron in the shell to the second metal in the shell is 50:50 to 75:25.

Aspect 6: The magnetic particle of any one or more of the foregoing aspects, wherein the shell comprises the iron nitride.

Aspect 7: The magnetic particle of any one or more of the foregoing aspects, wherein the iron oxide comprises magnetite, a metal iron oxide having a formula MₓFe_{y}O_{z}, wherein M comprises at least one of Co, Ni, Zn, V, Mn, or a combination thereof.

Aspect 8: The magnetic particle of any one or more of the foregoing aspects, wherein the iron oxide comprises a metal iron oxide of the formula MFe₂O₄, MFe₁₂O₁₉, Fe₃O₄, MFe₂₄O₄₁, or a combination thereof, wherein M comprises nickel, cobalt, or a combination thereof.

Aspect 9: The magnetic particle of at least one of the foregoing aspects, wherein the magnetic particle comprises irregularly-shaped particles, spherical particles, oval particles, rod-shaped particles, flakes, fibers, or a combination thereof.

Aspect 10: The magnetic particle of any one or more of the foregoing aspects, wherein a plurality of the magnetic particles has at least one of an average shortest dimension of the core of 10 nm to 5 mm, or 10 nm to 1 mm, or 10 nm to 1 micrometer, or 100 to 600 nm; or an average shell thickness of less than or equal to 1 micrometer, 1 nm to 500 micrometers, or 5 to 50 nm, or 5 to 10 nm.

Aspect 11: A method of forming the magnetic particle of any one or more of Aspects 1-10, comprising oxidizing the core with an oxidizing agent to form the shell; preferably wherein the oxidizing agent comprises oxygen, KMnO₃, H₂O₂, K₂Cr₂O₇, HNO₃, or a combination thereof.

Aspect 12: A magneto-dielectric material comprising: a polymer matrix; a plurality of the magnetic particles of any one or more of the preceding aspects; wherein the magneto-dielectric material has a magnetic loss tangent of less than or equal to 0.07 at 1 GHz.

Aspect 13: The magneto-dielectric material of Aspect 12, wherein the magneto-dielectric material comprises 5 to 60 vol % of the plurality of magnetic particles based on the total volume of the magneto-dielectric material.

Aspect 14: The magneto-dielectric material of any one or more of Aspects 12-13, wherein the magneto-dielectric material further comprises a dielectric filler, a flame retardant, or a combination thereof.

Aspect 15: The magneto-dielectric material of any one or more of Aspects 12-14 in the form of a layer, and further comprising a conductive layer disposed on a surface of the layer.

Aspect 16: The magneto-dielectric material of any one or more of Aspects 12-15, wherein the polymer matrix comprises a polyolefin, a polyurethane, a polyethylene, a silicone, a polyether, a poly(phenylene sulfide), a polybutadiene, a polyisoprene, a norbornene polymer, or a combination thereof.

Aspect 17: A method of making the magneto-dielectric material of any one or more of Aspects 12-16, wherein the polymer matrix comprises a thermoplastic polymer, and the method comprises injection molding the polymer and the plurality of magnetic particles.

Aspect 18: A method of making the magneto-dielectric material of any one or more of Aspects 12-16, wherein the polymer matrix comprises a thermoset polymer, and the method comprises reaction injection molding a polymer precursor composition and the plurality of magnetic particles.

Aspect 19: An article comprising the magneto-dielectric material of any one or more of Aspects 12-18.

Aspect 20: The article of Aspect 19, wherein the article is an antenna, a transformer, an anti-electromagnetic interface material, or an inductor.

Aspect 21: The article of Aspect 19, wherein the article is a microwave device.

Aspect 22: The article of any one or more of Aspects 19-21, comprising the magneto-dielectric material and a dielectric material that comprises 0 to 2 vol % of the magnetic particles based on the total volume of the dielectric material.

In general, the compositions, methods, and articles can alternatively comprise, consist of, or consist essentially of, any ingredients, steps, or components herein disclosed. The compositions, methods, and articles can additionally, or alternatively, be formulated, conducted, or manufactured so as to be devoid, or substantially free, of any ingredients, steps, or components not necessary to the achievement of the function or objectives of the present claims.

The terms “a” and “an” do not denote a limitation of quantity, but rather denote the presence of at least one of the referenced item. The term “or” means “and/or” unless clearly indicated otherwise by context. The endpoints of all ranges directed to the same component or property are inclusive of the endpoints, are independently combinable, and include all intermediate points. Disclosure of a narrower range or more specific group in addition to a broader range is not a disclaimer of the broader range or larger group. A “combination thereof” is open and included combinations of one or more of the named elements optionally together with one or more like element not named.

Unless defined otherwise, technical and scientific terms used herein have the same meaning as is commonly understood by one of skill in the art to which this disclosure belongs. The term “combination” is inclusive of blends, mixtures, alloys, reaction products, and the like. The permittivity and the permeability as used herein can be determined at a temperature of 23° C.

Reference throughout the specification to “an aspect”, “an aspect”, “another aspect”, “some aspects”, and so forth, means that a particular element (e.g., feature, structure, step, or characteristic) described in connection with the embodiment is included in at least one embodiment described herein, and may or may not be present in other embodiments. Thus, while certain combinations of features have been described, it will be appreciated that these combinations are for illustration purposes only and that any combination of any of these features can be employed, explicitly or equivalently, either individually or in combination with any other of the features disclosed herein, in any combination, and all in accordance with an aspect. Any and all such combinations are contemplated herein and are considered within the scope of the disclosure.

While the disclosure has been described with reference to exemplary aspects, it will be understood by those skilled in the art that various changes can be made and equivalents can be substituted for elements thereof without departing from the scope of this disclosure. In addition, many modifications can be made to adapt a particular situation or material to the teachings without departing from the essential scope thereof. Therefore, it is intended that the disclosure not be limited to the particular aspect disclosed as the best or only mode contemplated for carrying out this invention, but that the disclosure will include all aspects falling within the scope of the appended claims.

What is claimed is:

1. A magnetic particle, comprising:
a core comprising
iron, and
a second metal comprising cobalt, nickel, or a combination thereof,
wherein a core atomic ratio of the iron to the second metal is 50:50 to 75:25; and
a shell at least partially surrounding the core, and comprising
an iron oxide, an iron nitride, or a combination thereof; and
the second metal.

2. The magnet particle of claim 1, wherein the shell has at least one of
a higher resistivity than the core, or
a magnetic permeability of greater than or equal to 1 determined at 1 GHz.

3. The magnetic particle of claim 1, wherein
at least one of the core and the shell further comprises Cr, Ba, Au, Ag, Cu, Gd, Pt, Bi, Ir, Mn, Mg, Mo, Nb, Nd, Sr, V, Zn, Zr, N, C, or a combination thereof.

4. The magnetic particle of claim 1, wherein the core atomic ratio of the iron to the second metal is 60:40 to 70:30.

5. The magnetic particle of claim 1, wherein a shell atomic ratio of the iron in the shell to the second metal in the shell is 50:50 to 75:25.

6. The magnetic particle of claim 1, wherein the shell comprises the iron nitride.

7. The magnetic particle of claim 1, wherein the iron oxide comprises magnetite, a metal iron oxide having a formula MₓFe_{y}O_{z}, or a combination thereof; wherein M comprises at least one of Co, Ni, Zn, V, Mn, or a combination thereof.

8. The magnetic particle of claim 1, wherein the shell comprises the iron oxide; wherein the iron oxide comprises a metal iron oxide of the formula MFe₂O₄, MFe₁₂O₁₉, Fe₃O₄, MFe₂₄O₄₁, or a combination thereof; and wherein M comprises nickel, cobalt, or a combination thereof.

9. The magnetic particle of claim 1, wherein the magnetic particle comprises irregularly-shaped particles, spherical particles, oval particles, rod-shaped particles, flakes, fibers, or a combination thereof.

10. The magnetic particle of claim 1, wherein a plurality of the magnetic particles has at least one of
an average shortest dimension of the core is 10 nm to 5 mm; or
an average shell thickness is less than or equal to 1 micrometer.

11. A method of forming the magnetic particle of claim 1, comprising oxidizing the core with an oxidizing agent to form the shell.

12. A magneto-dielectric material comprising:
a polymer matrix; and a plurality of the magnetic particles;
wherein the plurality of the magnetic particles comprises magnetic particles that each independently comprise a core and a shell at least partially surrounding the core;
wherein the core comprises iron and a second metal comprising cobalt, nickel, or a combination thereof; wherein a core atomic ratio of the iron to the second metal is 50:50 to 75:25; wherein the shell comprises an iron oxide, an iron nitride, or a combination thereof and further comprises the second metal;
wherein the magneto-dielectric material has a magnetic loss tangent of less than or equal to 0.07 at 1 GHz.

13. The magneto-dielectric material of claim 12, wherein the magneto-dielectric material comprises 5 to 60 vol % of the plurality of magnetic particles based on the total volume of the magneto-dielectric material.

14. The magneto-dielectric material of claim 12, wherein the magneto-dielectric material further comprises a dielectric filler, a flame retardant, or a combination thereof.

15. The magneto-dielectric material of claim 12 in the form of a layer, and further comprising a conductive layer disposed on a surface of the layer.

16. The magneto-dielectric material of claim 12, wherein the polymer matrix comprises a polyolefin, a polyurethane, a polyethylene, a silicone, a polyether, a poly(phenylene sulfide), a polybutadiene, a polyisoprene, a norbornene polymer, or a combination thereof.

17. A method of making the magneto-dielectric material of claim 12, wherein the polymer matrix comprises a thermoplastic polymer, and the method comprises injection molding the polymer and the plurality of magnetic particles.

18. A method of making the magneto-dielectric material of claim 12, wherein the polymer matrix comprises a thermoset polymer, and the method comprises reaction injection molding a polymer precursor composition and the plurality of magnetic particles.

19. An article comprising the magneto-dielectric material of claim 12.

20. The article of claim 19, wherein the article is an antenna, a transformer, an anti-electromagnetic interface material, or an inductor; and/or wherein the articles is a microwave device.
